(19) United States
(12) Patent Application Publication
(10) Pub. No.: US 2015/0210078 A1
(43) Pub. Date: Jul. 30, 2015

(54) TO CONTROL A PRINT HEAD

(71) Applicant: Hewlett-Packard Industrial Printing Ltd., Netanya (IL)

(72) Inventors: Yochai EDLITZ, Netanya (IL); Dan BAVLI, Netanya (IL); Dennis INDORSKY, Netanya (IL); Ehud ELIASAF, Netanya (IL)

(21) Appl. No.: 14/606,599

(22) Filed: Jan. 27, 2015

(30) Foreign Application Priority Data
Jan. 27, 2014 (EP) 14152737.4

(51) Int. Cl. B41J 2/165

(52) U.S. Cl. CPC B41J 2/165

(57) ABSTRACT

An example method to reduce hydraulic cross talk within a print head, in which the provision of a cancellation signal to a first actuator, associated with a first nozzle, in accordance with the present disclosure is controlled to at least partially absorb a hydraulic pressure wave from a second nozzle, adjacent to the first nozzle, to reduce interference at the first nozzle, the provision of the cancellation signal being independent of the operation of the second nozzle.

### BACKGROUND

Inkjet printers usually include a print head comprising at least one nozzle for ejecting printing fluid. The print head also includes at least one actuator (such as a piezoelectric actuator or heat source) that provides a force to eject the printing fluid from the nozzle.

### BRIEF DESCRIPTION

Reference will now be made by way of example only to the accompanying drawings in which:

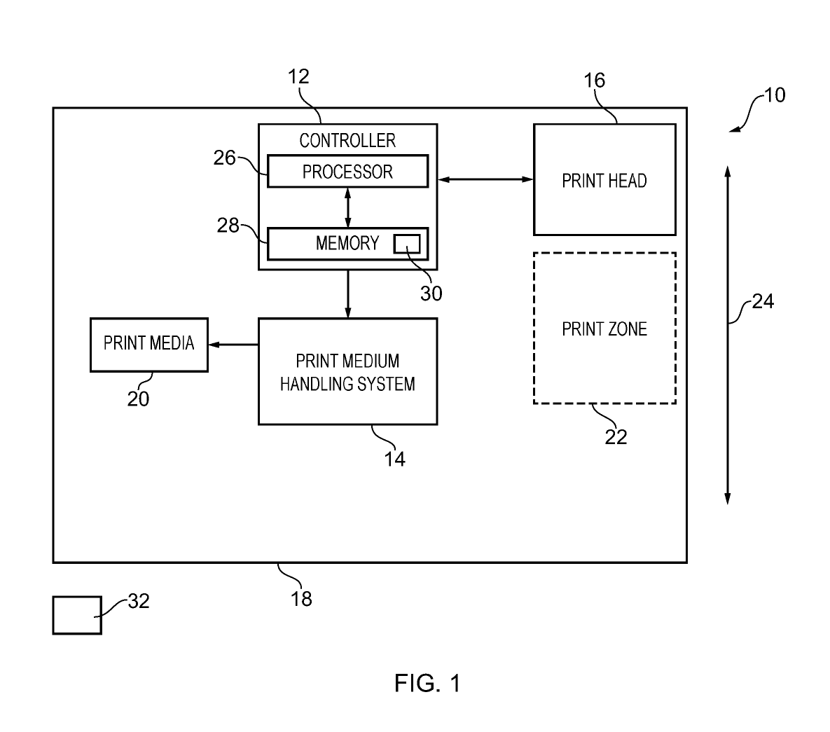

FIG. 1 illustrates a schematic diagram of an inkjet printing apparatus according to an example;

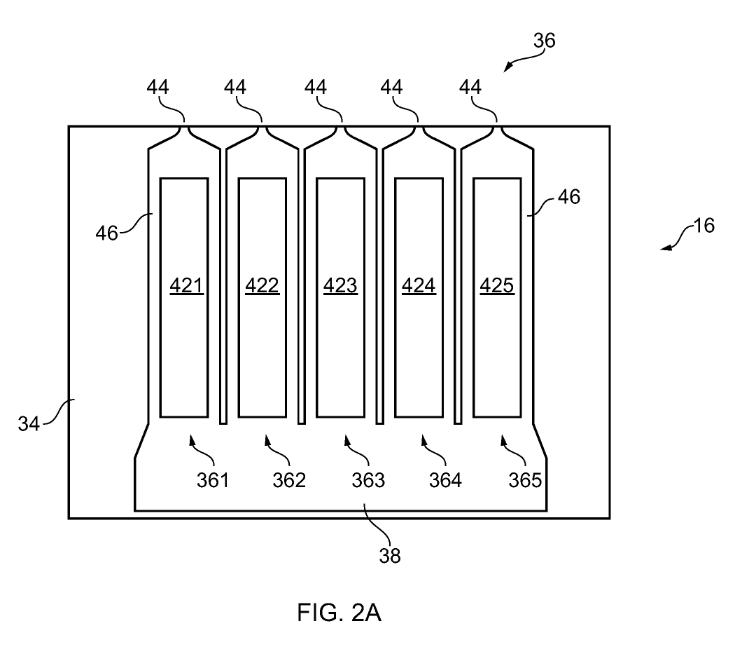

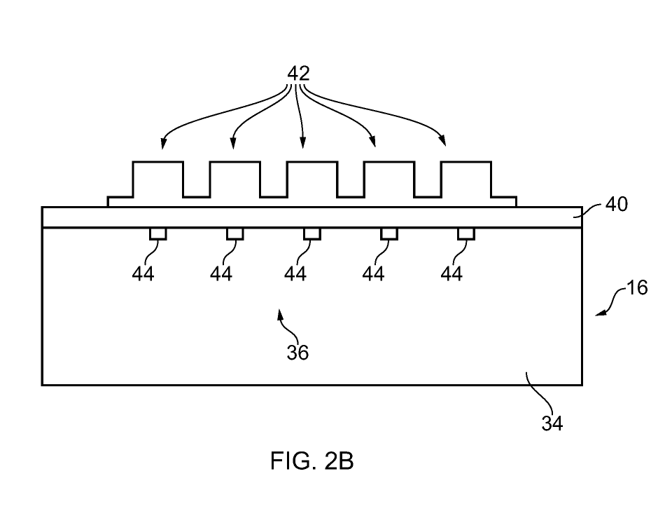

FIG. 2A illustrates a plan view diagram of a print head according to an example;

FIG. 2B illustrates a side view diagram of the print head illustrated in FIG. 2A;

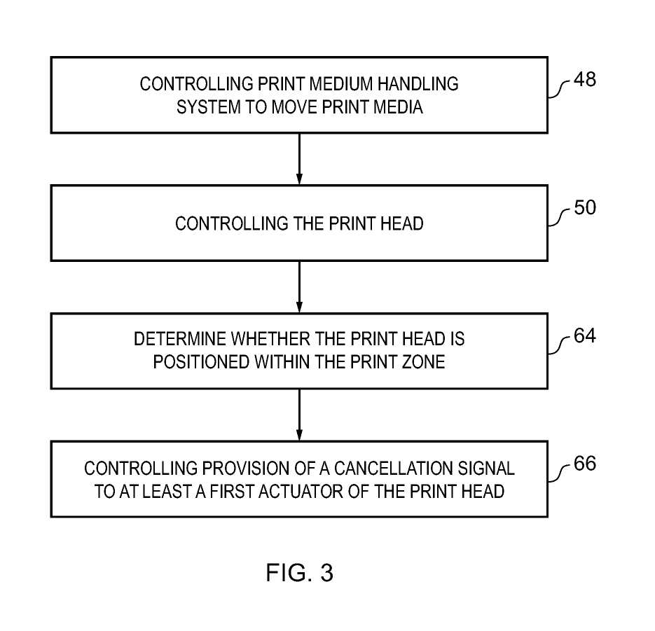

FIG. 3 illustrates a flow diagram of a method to reduce hydraulic cross talk within a print head according to an example;

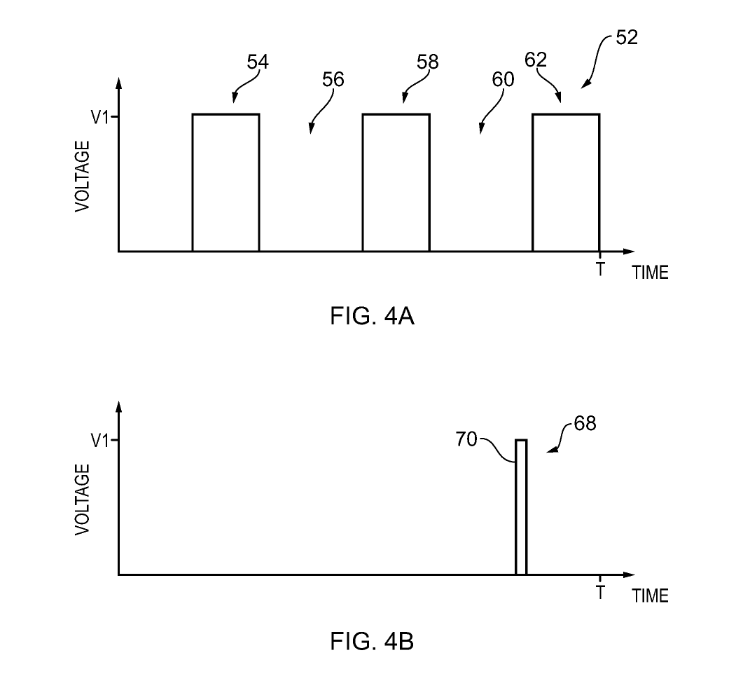

FIG. 4A illustrates a graph of voltage versus time for print signals according to an example; and

FIG. 4B illustrates a graph of voltage versus time for a cancellation signal according to an example.

### DETAILED DESCRIPTION

FIG. 1 illustrates a schematic diagram of an inkjet printer apparatus 10 according to an example. The inkjet printer apparatus 10 includes a controller 12, a print medium handling system 14, at least one print head 16 and a housing 18. In some examples, the inkjet printer apparatus 10 is an industrial press that has a relatively high throughput of print media.

In some examples, the apparatus 10 may be module. As used here, ‘module’ refers to a unit or apparatus that excludes certain parts/components that would be added by an end manufacturer or a user. For example, the apparatus 10 may comprise the controller 12, and the remaining components of the inkjet printer apparatus 10 may be added later by a different manufacturer.

The print medium handling system 14 may supply print media 20 to the inkjet printing apparatus 10. The print media 20 may comprise any suitable material, such as paper, card, transparencies, foils, and so on, depending upon the application.

In some examples, the at least one print head 16 may print on an intermediate material (for example, a blanket), and the intermediate material transfers printing fluid to the print media 20.

In more detail, the print medium handling system 14 may move the print media 20 from a feed tray to a print zone 22, and from the print zone 22 to an output tray. The print medium handling system 14 may include, for example, one or multiple motor-driven rollers.

In the print zone 22, the print media 20 may receive printing fluid (such as ink) from the print head 16. The inkjet printer apparatus 10 may comprise a plurality of print heads 16, which may include, for example, a black print head, and three color print heads, allowing full color printing. Alternatively, a single print head may be used alone to produce monochrome prints. Other alternatives may also be used.

The print head 16 may be transported by a carriage, which may be driven along a guide rod by a drive belt/pulley and motor arrangement. The print head 16 moves back and forth through the print zone 22 (as indicated by arrow 24) and over the print media 20. The print head 16 may selectively deposit one or more printing fluid droplets on the print media 16 in accordance with signals received from the controller 12. Consequently, the print head 16 is arranged to form an image and/or text on the print media 20.

As an alternative to comprising moving print heads, the inkjet printer apparatus 10 may comprise fixed print heads. In this apparatus, fixed print heads are positioned adjacent to a rotatable drum, upon which the print media is held (e.g. by vacuum pressure) in a print zone on the rotatable drum. The print heads may cover different portions of the print zone, so that as the drum rotates (either in one direction, or in two directions), printing fluid may be ejected onto all desired portions of the print media.

As an alternative, the inkjet printer apparatus 10 may comprise an array of fixed print heads and print media may be held on a flat bed (for example, by vacuum pressure). The media moves back and forth under the print heads to construct the image on the print zone.

The controller 12 may control the operation of the inkjet printer apparatus 10 (for example, the operation of the print medium handling system 14 and the print head 16). The implementation of the controller 12 can be in hardware alone (for example, a circuit, a processor and so on), have certain aspects in machine readable instructions or can be a combination of hardware and machine readable instructions.

The controller 12 may be implemented using instructions that enable hardware functionality, for example, by using executable computer program instructions in a general-purpose or special-purpose processor that may be stored on a computer readable storage medium (disk, memory etc) to be executed by such a processor. Consequently, the controller 12 may include at least one processor 26 and at least one memory 28.

The processor 26 may read from and write to the memory 28. The processor 26 may also comprise an output interface via which data and/or commands are output by the processor 26 and an input interface via which data and/or commands are input to the processor 26.

The memory 28 may store a computer program 30 comprising computer program instructions that control the operation of the apparatus 10 when loaded into the processor 26. The computer program instructions 30 may provide the logic and routines that enables the apparatus 10 to perform the methods illustrated in FIG. 3 and described below. The processor 26 by reading the memory 28 may load and execute the computer program 30.

The computer program 30 may arrive at the apparatus 10 via any suitable delivery mechanism 32. The delivery mechanism 32 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 30. The delivery mechanism 32 may be a signal to reliably transfer the computer program 30. The apparatus 10 may propagate or transmit the computer program 30 as a computer data signal.

Although the memory 28 is illustrated as a single component, it may be implemented as one or more separate components some or all of which may be integrated/removable and/or may provide permanent/semi-permanent/dynamic/cached storage.

FIGS. 2A and 2B illustrate a print head 16 according to an example. The inkjet printer apparatus 10 illustrated in FIG. 1 may comprise at least one print head 16 as illustrated in FIGS. 2A and 2B. The print head 16 may comprise: a substrate 34 that comprises a plurality of nozzles 36 and a chamber 38; a membrane 40; and a plurality of actuators 42.

The substrate 34 may comprise any suitable material, which may comprise silicon for example. The plurality of nozzles 36 and the chamber 38 are defined by the substrate 34 (in other words, the nozzles 36 and the chamber 38 are formed from cavities within the substrate 34). The nozzles 36 include openings 44 in a side of the substrate 34 and a plurality of corresponding firing chambers 46. The chamber 38 may receive printing fluid from a printing fluid reservoir (not illustrated in the Figs.) and provide the printing fluid to the plurality of nozzles 36. The chamber 38 may also be referred to as a ‘plenum area’ and is a common area to at least some of the firing chambers 44 of the nozzles 36 (in other words, the firing chambers 46 open out to the chamber 38 and are in fluid communication with one another via the chamber 38).

The membrane 40 as shown FIG. 2B may comprise any suitable material, which may comprise glass for example. The membrane 40 overlays the substrate 34 and is positioned between the substrate 34 and the plurality of actuators 42.

The plurality of actuators 42 may comprise any suitable actuators for providing a force to eject printing fluid from the plurality of nozzle 36. For example, the plurality of actuators 42 may comprise piezo electric actuators or thermal actuators. The plurality of actuators 42 overlay the plurality of nozzles 36. In particular, as shown in FIG. 2A, a first actuator 421 overlays a first nozzle 361, a second actuator 422 overlays a second nozzle 362, a third actuator 423 overlays a third nozzle 363, a fourth actuator 424 overlays a fourth nozzle 364, and a fifth actuator 425 overlays a fifth nozzle 365.

The controller 12 may control the provision of signals to the plurality of actuators 42 so that the actuators 42 provide a force to the nozzles 36 to eject printing fluid. For example, where the plurality of actuators 42 are a plurality of piezo electric actuators, the signal from the controller 12 causes the piezo electric actuators to change shape and thereby provide a force to the nozzles 36. In some examples, the controller 12 may directly provide signals to the plurality of actuators 42. In other examples, the controller 12 may control other circuitry to provide signals to the plurality of actuators 42.

The operation of the inkjet printer apparatus 10 is described in the following paragraphs with reference to FIG. 3.

At block 48, the controller 12 controls the print medium handling system 14 to move the print media 20 from an in-tray to the print zone 22.

At block 50, the controller 12 controls the print head 16 to move through the print zone 22 and also controls the print head 16 to provide printing fluid to the print media 20. In particular, the controller 12 controls the provision of signals to the plurality of actuators 42 to eject printing fluid from the nozzles 36 of the print head 16.

The controller 12 and print head 16 may operate in a single drop mode whereby the signal has a single peak within a printing time period and a nozzle 36 ejects one drop of printing fluid in that time period. The controller 12 and the print head 16 may also operate in a double drop mode whereby the signal has two peaks (having a time delay there between) within a printing time period and a nozzle ejects two drops of printing fluid in that time period. Additionally, the controller 12 and the print head 16 may also operate in a triple drop mode whereby the signal has three peaks (having a time delay between each peak) within a printing time period and a nozzle 36 ejects three drops of printing fluid in that time period. Furthermore, the controller 12 and the print head 16 may operate in an idle mode whereby a cancellation signal is provided to an actuator (that is, no printing signal is sent to an actuator) and this is described in more detail in the following paragraphs.

FIG. 4A illustrates an example graph of voltage versus time for a triple drop mode signal 52 from the controller 12. The signal 52 includes a first peak 54, a first time delay 56, a second peak 58, a second delay 60 and a third peak 62 that occur within a printing time period T of the print head 16 for printing a dot on the print media 20. The first peak 54, the second peak 58 and the third peak 62 have a voltage amplitude of V1.

In some examples, actuators may be kept while idle (for example, no jetting is required) with a voltage amplitude of V1. The jetting is performed when releasing this voltage amplitude which causes a deformation of the actuator (for example, a piezo electric actuator).

In FIG. 3, at block 64, the controller 12 may determine whether the print head 16 is positioned within the print zone 22. In more detail, the print head 16 may move outside of the print zone 22 on either side of the print zone 22. The controller 12 may determine whether the print head 16 is positioned within the print zone 22, or whether the print head 16 is positioned outside of the print zone 22.

As an alternative, the print head 16 might be positioned within the print zone 22. However, based on the printed image not all of the nozzles of the print head 16 may eject a drop of printing fluid. The controller 12 at block 64 may also analyze the image to be printed and assign a fire signal to all the nozzles within the print zone 22 that should fire a drop of printing fluid and leaving other nozzles idle.

Moreover, in order to control the print quality, different print modes may be used. A print mode is a set of parameters sent to the print engine and controlled by the controller 12. Among which, it determines how many times the print media 20 moves below the at least one print head 16 in order to create the image.

Splitting the data between these print cycles is done by the controller 12 (using a predefined mask). Increasing the number of print cycles will typically increase the print quality. The result of this procedure is that not all nozzles within the print zone 22 may eject a drop in each print cycle.

At block 66, the controller 12 controls provision of a cancellation signal to at least one actuator 42 of the print head 16.

When the controller 12 controls the print head 16 to eject printing fluid, at least some of the actuators 42 may generate a hydraulic pressure wave which travels via the chamber 38 from those nozzles 36 that ejected printing fluid, to other nozzles within the print head 16, including those nozzles 36 that did not eject printing fluid. The hydraulic pressure wave may cause the nozzles 36 that did not eject printing fluid, to eject printing fluid or be in an unsteady state.

The controller 12 may control the provision of a cancellation signal to at least one actuator, associated with a nozzle, to at least partially absorb a hydraulic pressure wave from another nozzle, adjacent to the nozzle, to reduce interference at the nozzle. The provision of the cancellation signal may be independent of the operation of the other nozzle.

In one example, the controller 12 controls the second actuator 422 of the print head 16 to eject printing fluid from the second nozzle 362 shown in FIG. 2A. The controller 12 controls the second actuator 422 to eject a triple drop (as described above with reference to FIG. 4A) from the second nozzle 362. In other examples, the controller 12 may control the second actuator 422 to alternatively eject a single drop, a double drop or any plurality of drops. The force provided by the second actuator 422 on the second nozzle 362 generates a hydraulic pressure wave which travels via the chamber 38 to the first nozzle 361 (and the other nozzles of the print head 16).

The controller 12 controls the provision of a cancellation signal to the first actuator 421 that is associated with the first nozzle 361. The cancellation signal may be provided to those actuators that are in an idle mode and not causing their respective nozzles to eject printing fluid (in other words, the cancellation signal is provided to those actuators not receiving a printing signal). The cancellation signal causes the first actuator 421 to provide a force to the first nozzle 361 and generates a hydraulic pressure wave in the first nozzle 361. The timing of the cancellation signal is selected so that the hydraulic pressure wave from the first actuator 421 at least partially destructively interferes with the hydraulic pressure wave from the second actuator 422. Consequently, the provision of the cancellation signal causes at least partial absorption of the hydraulic pressure wave from the second nozzle 362 at the first nozzle 361. The cancellation signal has an amplitude and duration that causes actuation of the first actuator 421 without causing ejection of printing fluid from the first nozzle 421.

FIG. 4B illustrates a graph of voltage versus time for a cancellation signal 68 according to an example. The cancellation signal 68 includes a peak 70 that is provided within the printing time period T of the print head 16 for printing a dot on the print media 20. The peak 70 has an voltage amplitude of V1 (that is, the peak 70 of the cancellation signal 68 has the same voltage amplitude as the first, second and third peaks 54, 58, 62 of the printing signal 52). In other examples, the peak 70 may have a different voltage amplitude to the first, second and third peaks 54, 58, 62. The peak 70 of the cancellation signal 68 is timed to be within the second delay 60 of the signal 52.

The provision of the cancellation signal is independent of the operation of other nozzles within the print head 16. In other words, the controller 12 does not analyze the signals sent to the other nozzles within the print head 16 to determine the timing of the cancellation signal.

In some examples, the timing of the cancellation signal is determined empirically during the design and manufacture of the inkjet printer apparatus 10 and is stored in the memory 28. For example, various different timings of the cancellation signal may be tested to determine the timing that provides the fewest number of mis-fired nozzles and therefore the best quality print output from the inkjet printer apparatus 10. The determined optimal timing for the cancellation signal may then be stored in the memory 28 for later operation of the inkjet printer apparatus 10.

In other examples, the timing of the cancellation signal may be calculated during design and manufacture of the inkjet printer apparatus 10 by taking into account the speed of sound of the printing fluid to be ejected from the print head 16, and the Helmholtz frequency of the print head 16, and then stored in the memory 28. Consequently, the cancellation signal may be provided at a fixed predetermined time within the printing time period T for a given printing fluid, and printing mode (i.e. double drop, triple drop etc.). In some examples, the memory 28 may store a plurality of different timings for the cancellation signal for different printing fluids and different printing modes.

In some examples, the controller 12 may use the determination in block 64 so that the cancellation signal is provided to an actuator 42 when the print head 16 is positioned within the print zone 22. This may advantageously prevent over-heating of the print head 16 caused by the provision of the cancellation signal.

The controller 12 may then repeat the method illustrated in FIG. 3 so that a new portion of the print media 20 is moved into the print zone 22 and receives printing fluid from the print head 16. The method illustrated in FIG. 3 is repeated until printing on the print media 20 is completed.

The inkjet printer apparatus 10 may provide several advantages. Firstly, the provision of the cancellation signal may improve the print quality of the inkjet printer apparatus 10 because the cancellation signal helps to reduce or eliminate hydraulic pressure waves from adjacent firing nozzles at a non-firing nozzle. This may help to reduce the likelihood of a non-firing nozzle from ejecting printing fluid. Additionally, the cancellation signal may help the non-firing nozzle to be able to eject a drop of printing fluid from a steady state, rather than from an excited state caused by the hydraulic pressure wave.

Secondly, the provision of the cancellation signal advantageously does not affect the duration of the printing time period. In more detail, the cancellation signal is provided within the printing time period T and does not increase the length of the printing time period T. Consequently, the provision of the cancellation signal advantageously does not reduce the throughput of print media 20 of the inkjet printer apparatus 10.

Thirdly, since the voltage amplitude V1 of the cancellation signal is the same as the voltage amplitude V1 of the print signal, the provision of the cancellation signal advantageously does not require any additional circuitry.

Fourthly, the provision of the cancellation signal may advantageously enable the use of low viscosity inks with high cross talk characteristics in the print head 16. Consequently, the provision of the cancellation signal may enable the use of low cost inks and more freedom in engineering new inks.

Fifthly, the cancellation signal is provided independently of the operation of the adjacent nozzles and consequently the provision of the cancellation signal advantageously does not require any knowledge of the operation of the adjacent nozzles or processing power in its calculation.

Sixthly, as mentioned in the preceding paragraph, the cancellation signal may be provided to any actuator of any non-firing nozzle, even if adjacent nozzles are not firing. Advantageously, the provision of the cancellation signal may prevent the degradation of the operation of a non-firing nozzle by maintaining the non-firing nozzle at a relatively constant temperature and in good condition (the cancellation signal may help to reduce ink sedimentation for example). In such examples, the cancellation signal may not reduce hydraulic cross talk since adjacent nozzles may not be ejecting printing fluid and creating hydraulic pressure waves in the chamber 38. In these examples, the cancellation signal may be referred to as a signal or as a maintenance signal.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi- processor architectures and sequential (Von Neumann)/parallel architectures but also specialized circuits such as field-programmable gate arrays (FPGA), application specific circuits (ASIC), signal processing devices and other processing circuitry.

References to computer program, instructions, code etc. should be understood to encompass machine readable instructions for a programmable processor or the programmable content of a hardware device whether instructions for a processor, or configuration settings for a fixed-function device, gate array or programmable logic device etc.

The blocks illustrated in the FIG. 3 may represent steps in a method and/or sections of code in the computer program 30. The illustration of a particular order to the blocks does not necessarily imply that there is a required or preferred order for the blocks and the order and arrangement of the block may be varied in some examples. Furthermore, it may be possible for some blocks to be omitted in some examples.

Although examples of the present disclosure have been described in the preceding paragraphs, it should be appreciated that modifications to the examples given can be made without departing from the scope of the disclosure as claimed. For example, the print head 16 may have a different structure to the print head illustrated in FIGS. 2A and 2B. The controller 12 may be a controller of the inkjet printer apparatus 10, or may be a controller of the print head 16, and may be located within the print head 16.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

What is claimed is:

1. A method to reduce hydraulic cross talk within a print head, the method comprising:
controlling provision of a cancellation signal to a first actuator, associated with a first nozzle, to at least partially absorb a hydraulic pressure wave from a second nozzle, adjacent to the first nozzle, to reduce interference at the first nozzle, the provision of the cancellation signal being independent of the operation of the second nozzle.

2. The method of claim 1, further comprising: determining whether the print head is positioned within a print zone, the cancellation signal being provided to the first actuator when the print head is positioned within the print zone.

3. The method of claim 1, wherein the cancellation signal has an amplitude and duration that causes actuation of a first actuator without causing ejection of printing fluid from the first nozzle.

4. The method of claim 1, wherein the first actuator receives a print signal having a voltage level, the cancellation signal having a voltage level that is the same as the voltage level of the print signal.

5. The method of claim 1, wherein the cancellation signal is provided within a printing time period of the print head for printing a dot, and the provision of the cancellation signal does not affect the duration of printing time period.

6. The method of claim 1, wherein the cancellation signal is provided within a printing time period of the print head for printing a dot, the cancellation signal being provided at a fixed predetermined time within the printing time period.

7. The method of claim 1, wherein the first nozzle has an idle mode in which the first nozzle does not eject printing fluid, and at least one printing mode in which the first nozzle ejects printing fluid, the cancellation signal being provided to the first nozzle while the first nozzle is in the idle mode.

8. The method of claim 1, wherein the cancellation signal is provided within a printing time period of the print head for printing a dot, timing of the provision of the cancellation signal within the printing time period being determined empirically.

9. The method of claim 1, further comprising controlling provision of at least a first printing signal and a second printing signal to a second actuator, associated with the second nozzle, to cause the second nozzle to print a dot, the cancellation signal being provided to the first actuator after the provision of the second printing signal to the second actuator.

10. An apparatus to reduce hydraulic cross talk within a print head, the apparatus comprising:
a controller to control provision of a cancellation signal to a first actuator, associated with a first nozzle, to at least partially absorb a hydraulic pressure wave from a second nozzle, adjacent to the first nozzle, to reduce interference at the first nozzle, the provision of the cancellation signal being independent of the operation of the second nozzle.

11. The apparatus of claim 10, wherein the controller is to determine whether the print head is positioned within a print zone, the cancellation signal being provided to the first actuator when the print head is positioned within the print zone.

12. The apparatus of claim 10, wherein the cancellation signal has an amplitude and duration that causes actuation of the first actuator without causing ejection of printing fluid from the first nozzle.

13. The apparatus of claim 10, wherein the first actuator receives a print signal having a voltage level, the cancellation signal having a voltage level that is the same as the voltage level of the print signal.

14. The apparatus of claim 10, wherein the controller is to control provision of at least a first printing signal and a second printing signal to a second actuator, associated with the second nozzle, to cause the second nozzle to print a dot, the cancellation signal being provided to the first actuator after the provision of the second printing signal to the second actuator.

15. A method to prevent degradation of operation of nozzles in a print head, comprising:
controlling provision of a signal to a first actuator, associated with a first nozzle in a print head, wherein when no print data is being sent to the first actuator, the signal is sent to prevent degradation in the operation of the first nozzle, and the provision of the signal is independent of operation of other nozzles within the print head.
